(19) United States
(12) Patent Application Publication
(10) Pub. No.: US 2017/0122252 A1
(43) Pub. Date: May 4, 2017

(54) MODULE WITH PRE-ORIENTED CAMSHAFT

(71) Applicant: ThyssenKrupp Presta TecCenter AG, Eschen (LI)

(72) Inventors: Heiko Schmid, Nendeln (LI); Ulrich Schatton, Feldkirch (AT); Hans Jürgen Schmidt, Tirschenreuth (DE)

(73) Assignee: ThyssenKrupp Presta TecCenter AG, Eschen (LI)

(21) Appl. No.: 15/301,919

(22) PCT Filed: Mar. 30, 2015
(86) PCT No.: PCT/EP2015/056902

§ 371 Date: Oct. 4, 2016

(30) Foreign Application Priority Data
Apr. 8, 2014 (DE) 10 2014 104 995.0

(51) Int. Cl. F02F 7/00; F02F 1/24; F01L 1/46; F01L 1/053

(52) U.S. Cl. CPC F02F 7/0043; F01L 1/053; F02F 1/24; F01L 1/46; F01L 2250/06; F01L 2250/04

(57) ABSTRACT

A module may include a receiving element in the form of a bearing frame or a covering hood for arrangement on a cylinder head of an internal combustion engine. The module may further include a camshaft that is rotatably mounted on the receiving element and projects from the receiving element to hold a camshaft wheel. The module can be prefabricated for direct mounting on the cylinder head. In the prefabrication process, the camshaft may be locked against rotation by an externally accessible securing part in an angular position for acting on valves. The securing part may extend through a first aperture in the camshaft wheel and through or into a receptacle of the receiving element. After mounting the module on the cylinder head, the securing part can be removed.

The invention relates to a module comprising a receiving element, in particular in the form of a bearing frame or a covering hood, for arrangement on a cylinder head of an internal combustion engine. The module additionally has at least one camshaft which is rotatably mounted in the receiving element and which, for holding a camshaft wheel, projects out of a face side of the receiving element. The module is prefabricated for direct mounting on the cylinder head.

### PRIOR ART

The increasing wide variety of technologies used in the drive train of a vehicle demands of the engine manufacturers a high flexibility in the process chain and an associated reduction in the production costs. Therefore, development is tending toward a modularization of the components and toward an integration of additional functions in the components. In the course of this development there have been designed, for example, camshaft modules in which one or two camshafts are preassembled in a bearing frame as part of the cylinder head or in a covering hood as a complete cylinder head. Such prefabricated camshaft modules need only be placed on the cylinder block when mounting the combustion engine. The only remaining manufacturing step is the mounting of traction means, in particular the toothed belt or the timing chain, on the camshaft wheel.

To ensure that the timing ratio, given by the angular position, between camshafts and crankshafts corresponds to the predetermined degree, attention must be paid when mounting the traction means on the camshaft wheel to the exact angular position of the cams acting on the valves in terms of the two camshafts with respect to the valves on the one hand and with respect to the crankshaft on the other hand. Setting the correct angle between the rotating components involved is time-consuming and negatively influences the manufacturing costs.

In order, in conventional combustion engines, to be able to fix the angular position of the camshafts for mounting, it is known from WO2004/106716 A1 to secure a camshaft with a bolt which is guided through the cylinder head from above and which engages through a bore or a notch in the camshaft and is fixed in the cylinder block. The bolt can also assume the function of a mounting aid when assembling the engine. However, the design measures on the camshaft are great and negatively affect the stability of the camshaft. In addition, handling the bolt is uncomfortable insofar as the bore or notch in the camshaft cannot be seen from outside.

DE 10 2007 056 608 A1 discloses a tool which is used only during repairs in order to temporarily fix the position of the camshafts that exists prior to demounting a V-belt or timing chain. This tool engages in the teeth of the toothed wheel and is braced against the engine block by means of a screw. However, this tool only allows a provisional and temporary fixing of the camshafts. The engagement of the tool in the toothed wheel functional surface can also lead to damage or to remaining abrasion on the camshaft wheel.

It is therefore the object of the present invention to provide a cost-effective module of simple design comprising the receiving element and one or more camshafts which, within the scope of mounting of internal combustion engines, is to be mounted in few steps, reliably ensures the fixing of the camshaft(s) in a predetermined angular position until the mounting of a traction means on the camshaft wheel and allows simple termination of the fixing after mounting.

This object is achieved by a module as claimed in claim 1. Advantageous embodiments of the module according to the invention are described in the dependent claims.

In accordance with the claims, an essential aspect of the invention first consists in ensuring particularly simple and rapid mounting for the prefabricated module consisting of receiving element and camshaft(s) using the securing part which engages in the camshaft wheel. Here, the particular feature consists in the fact that the securing part engages in the externally accessible camshaft wheel while protecting its toothed rim and, despite a simple mechanical design, fixes it particularly reliably with respect to the receiving element. Consequently, the angular position of the camshafts which is predetermined for the installation of the module is reliably fixed.

Here, the module is prefabricated for direct mounting on the cylinder head of a combustion engine in accordance with the claims due to the fact that the cams of the camshaft are first situated in the angular position for acting on the valves that is predetermined by the correct timing ratio. In this angular position, the camshaft is locked against rotation by the securing part which is externally accessible for handling, wherein the securing part engages through an aperture in the camshaft wheel and is in positive connection, against rotation, with a receptacle provided therefor in the receiving element, with the result that the camshaft wheel is blocked with respect to the receiving element. After mounting the module on the internal combustion engine, the securing part is removed from the locking position by a simple manipulation.

Any prefabricated modules comprising a receiving element and preassembled camshafts can be equipped with the securing part designed in such a way. However, a very particularly suitable application is those modules in which the camshafts have been inserted into correspondingly coaxially arranged through-bores in the receiving element using thermal shrinking and expansion processes. In this joining process, the body of the camshaft is first cooled and thus shrunk to such an extent that it can be inserted into the through-bores via bearings. During insertion, the cams are “threaded on” at the same time. With heating and corresponding expansion, the body of the camshaft is pressed at the intended locations into bearings and into the cams.

The substantial advantage of a module prefabricated and prepositioned in such a way is that it can be directly installed in engine assembly and that a complicated manufacturing step is saved because of the reliable fixing of the camshafts. Here, the use of the securing part according to the invention ensures a particularly gentle (since it does not act on the toothed rim) and nevertheless robust and precise fixing of the camshafts in the receiving element. In addition, the securing part according to the invention can be handled particularly simply during installation and during removal.

Advantageously, the camshaft wheel, which is in particular a toothed wheel or belt (wheel), is designed from the outset specifically for the use of a securing part which can be handled particularly simply. For this purpose, the disk surface of the wheel is breached by a first aperture at least at one point apposite to an element of the securing part that engages through, wherein it is structurally particularly simple if this first aperture is formed as a cylindrical bore which is penetrated by a complementarily formed cylindrical pin of the securing part. The pin then reaches into a further receptacle, provided in the receiving element, in the form of a bore which at the correct angular position is aligned with the bore in the camshaft wheel. Here, care must be taken in each case to ensure a corresponding fit which allows the sliding of the pin in spite of a radial positive connection which is as strong as possible.

In addition, it is advantageous for there to be provided in the disk surface at least one second aperture for holding the securing part, wherein the securing part is equipped with a corresponding holding means which interacts with the second aperture. The holding means thus fixes the securing part mounted in the camshaft wheel and prevents the axial displacement of the pin in the process.

In a particularly advantageous embodiment, the holding means is equipped at least with a flexible clip leg on whose end there is situated a latching lug. The clip leg engages in the second aperture, with the latching lug engaging behind the edge of the aperture if the holding means is in contact on the other side with the outer surface of the camshaft wheel.

Ideally, the holding means has two clip legs which are connected via a tilt joint and correspondingly engage in a latching manner in two apertures. Here—as in the case of a clothes peg—a spring action is to be provided which closes the two clip legs. The two ends of the clip legs that are equipped with the latching lugs thus form a clip head and the other ends of the clip legs form externally accessible handles. Owing to the tilt joint, pressing together the grips brings about an opening and thus an unlocking of the clip head.

It is particularly advantageous if the securing part, which is equipped in particular with the pin and the two clip legs connected resiliently via the tilt joint, are manufactured as a one-piece plastic injection-molded part. On the one hand, such a securing part can be produced simply and cost-effectively and can be treated as a disposable article. Moreover, it combines low weight with high stability. An essential advantage is that the pin can be manufactured with a high fit accuracy and, owing to the difference in material, can be easily inserted into the bore. With regard to the simple sliding in the bores combined nevertheless with a high fit accuracy, and to compensate for any manufacturing tolerances, it is particularly advantageous to equip the walls of the pin with axial slots which produce a limited radial flexibility.

In a further advantageous embodiment, the securing part is provided with a tamper-evident means, for example a seal, which breaks during first-time removal of the securing part from the locking position and thus makes visible the manipulation. Such a tamper-evident means makes it possible during installation of the module to ensure that it is a module in the original state in which the correct angular position is guaranteed.

### PREFERRED EXEMPLARY EMBODIMENT OF THE INVENTION

An embodiment of the module according to the invention is explained in more detail below with reference to the figures, in which:

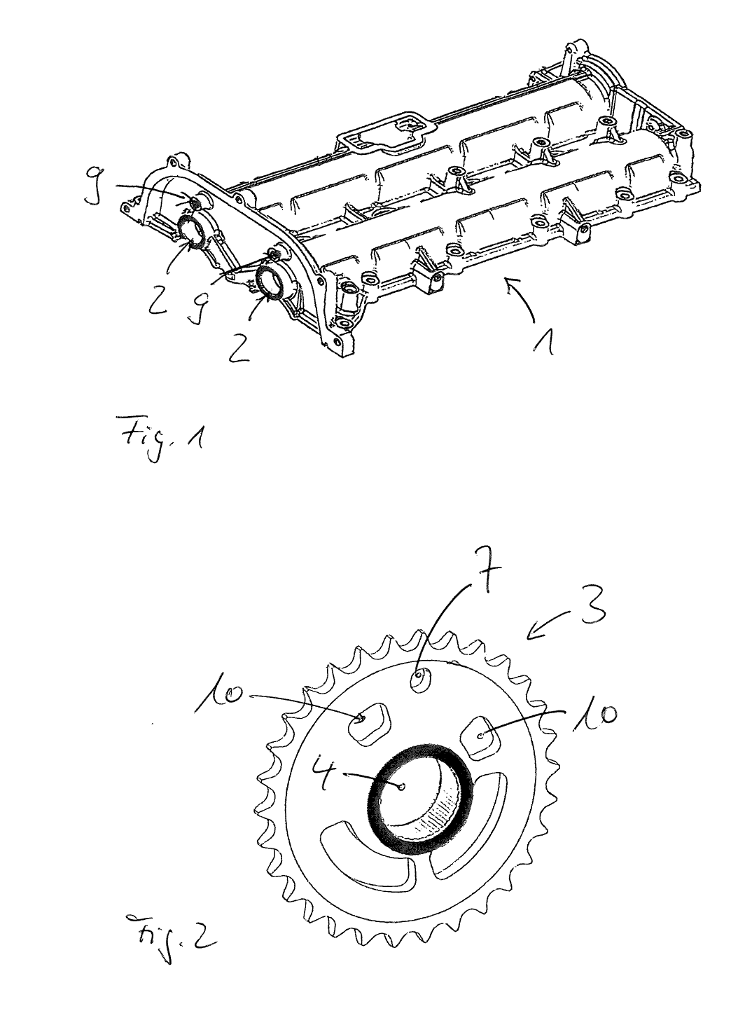

FIG. 1 shows a covering hood for receiving two camshafts,

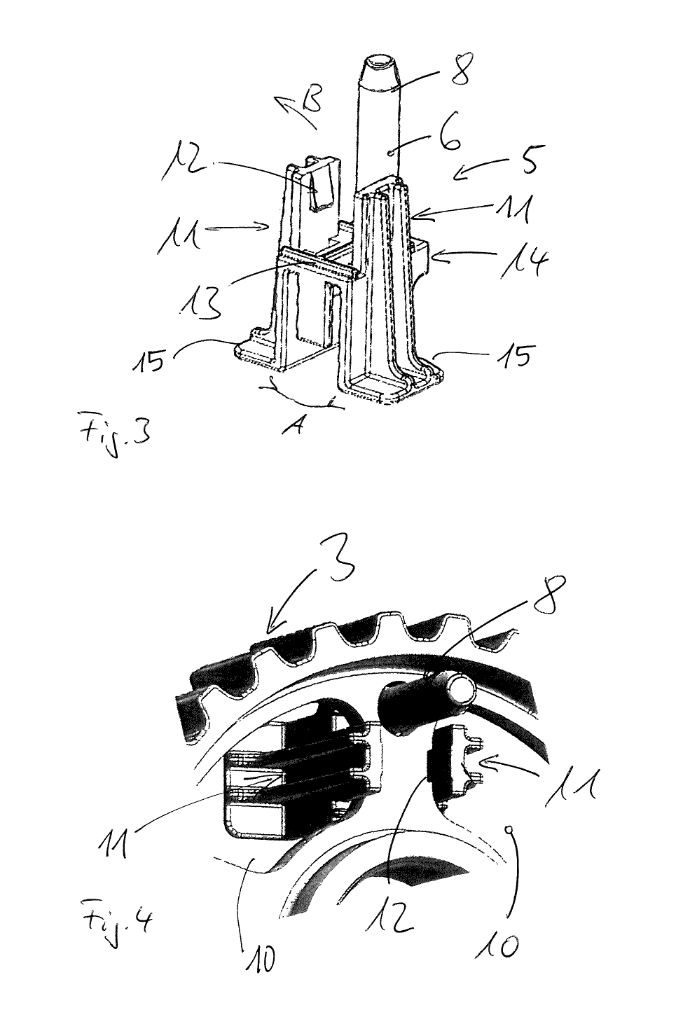

FIG. 2 shows a camshaft wheel with openings,

FIG. 3 shows a securing part produced in one piece from plastic,

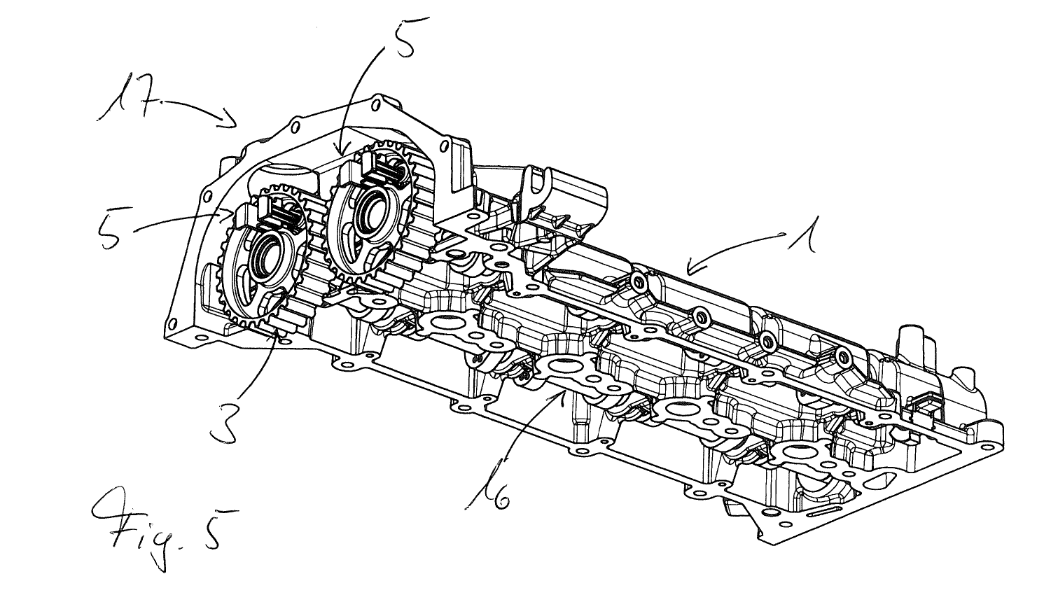

FIG. 4 shows a securing part mounted in a camshaft wheel, and

FIG. 5 shows a module consisting of covering hood and installed camshafts.

FIG. 1 first shows, as part of a module equipped according to the invention, a receiving element in the form of a prefabricated covering hood 1 which is suitable for placing on a cylinder head of an internal combustion engine. Two bores 2 are made in one face of the covering hood 1, out of which bores there correspondingly project two camshafts 16 (see FIG. 5) to be mounted rotatably in the covering hood 1. A receptacle 9 in the form of a securing bore which receives the securing part is made in the face of the covering hood 1 above each bore 2.

FIG. 2 shows a camshaft wheel 3 equipped according to the invention in the form of a toothed wheel as is mounted by means of a central bore 4 on ends of the camshafts 16 that project on the face out of the bores 2 of the covering hood 1. The module shown in FIG. 5, consisting of the covering hood 1, the two camshafts 16 and the camshaft wheels 3, is prefabricated for direct mounting on the cylinder head of an internal combustion engine.

For mounting, each of the camshafts is locked against an unintended rotation before or during mounting by an externally accessible plastic securing part 5, illustrated in FIG. 3, in the angular position which is correct for acting on the valves. For locking, the securing part 5 mounted on the camshaft wheel 3 first of all penetrates by way of a pin 6 through an aperture 7 in the form of a through-bore made in the inner disk of the camshaft wheel 3 seated on the camshaft 16. In the process, the pin 6 reaches through the through-bore and by way of its tip 8 into the receptacle 9 (FIG. 1), configured as a securing bore, in the covering hood 1.

The tip 8 of the securing part 5 is in radial positive connection with the receptacle 9 and fixes the camshaft 16 against rotation. Here, the through-bore 7 and the receptacle 9 are dimensioned in their diameter such that they form a sliding fit for the pin 6. The securing part 5 is designed overall such that, after mounting the module on the cylinder head, it can be removed from its formerly locking position with a simple manipulation. In the present case, the securing part 5 is completely removed and can be disposed of or reused.

To retain the securing part 5 on the camshaft wheel 3 (see also FIG. 4), two second apertures 10 arranged symmetrically around the through-bore 7 are provided in the surface of the camshaft wheel 3. A flexible clip leg 11 with which the securing part 5 is equipped engages in each of these second apertures 10. Each clip leg 11 has a latching lug 12 which engages behind an edge of the respective aperture 10. The securing part 5 lies by way of a bearing surface 13 against the front edge of the aperture 10 and thus against the surface of the camshaft wheel. The securing part 5 with the pin 6 and the two clip legs 11 is injection-molded in one piece from plastic, with the two clip legs 11 being integrally formed on a bridge part 14 forming the bearing surface 13 in such a way that the connection forms a resilient tilt joint.

The spring force produced by the one-piece construction closes the clip legs 11, with the result that the latching lugs 12 latch in with the securing part 5 mounted. The ends of the clip legs 11 that are equipped with the latching lugs 12 form as it were a clip head. By contrast, the other ends of the clip legs form two externally accessible handles 15 which, when pressed together in arrow direction A, open the clip head (arrow B).

FIG. 5, now, shows the module with the covering hood 1 and two camshafts 16 which are mounted therein and of which the ends project out of an end side 17 of the covering hood 1 and carry the camshaft wheels 3. The module is prefabricated insofar as the camshafts 16 are secured against rotation in the predetermined angular position by means of the securing parts 5 used. This module can be mounted directly on the cylinder head of an internal combustion engine.

### LIST OF REFERENCE SIGNS

1 Receiving element in the form of a covering hood

2 Bores in the covering hood

3 Camshaft wheel

4 Central bore

5 Securing part

6 Pin

7 First aperture in the form of a through-bore

8 Tip of the pin

9 Receptacle in the form of a securing bore

10 Second apertures

11 Clip legs

12 Latching lug

13 Bearing surface

14 Bridge part

15 Handles

16 Camshaft

17 Face of the covering hood

1.-10. (canceled)

11. A module comprising:
a receiving element that is configured as a bearing frame or a covering hood and is positionable on a cylinder head of an internal combustion engine, the receiving element comprising a receptacle;
a camshaft that is rotatably mounted on the receiving element, wherein the camshaft projects out of a face of the receiving element for holding a camshaft wheel; and
an externally accessible securing part that locks the camshaft against rotation in an angular position for acting on valves, wherein prior to removal the externally accessible securing part extends through an aperture in the camshaft wheel and through or into the receptacle of the receiving element to prevent rotation of the camshaft wheel,
wherein the module is prefabricated for direct mounting on the cylinder head of the internal combustion engine.

12. The module of claim 11 wherein the camshaft wheel is a toothed wheel or a belt wheel in whose surface is the aperture configured as a bore for receiving a pin of the externally accessible securing part, wherein a sliding fit is provided between the pin and the bore, wherein the pin extends through the bore into the receptacle in the receiving element, wherein the receptacle in the receiving element is configured as a securing bore.

13. The module of claim 12 wherein the aperture is a first aperture, the camshaft wheel further comprising a second aperture for holding the externally accessible securing part, wherein the externally accessible securing part is equipped with holding means that engages the second aperture and axially secures the pin.

14. The module of claim 13 wherein the externally accessible securing part with the pin and the holding means is manufactured as a one-piece plastic injection-molded part.

15. The module of claim 14 wherein the pin has an axially slotted wall intended to limit radial flexibility.

16. The module of claim 13 wherein the holding means comprises a flexible clip leg with a latching lug, wherein the flexible clip leg engages in the second aperture in the camshaft wheel, wherein the latching lug engages behind an edge of the second aperture.

17. The module of claim 16 wherein the flexible clip leg is a first flexible clip leg, the holding means further comprising a second flexible clip leg with a latching lug, with the first and second flexible clip legs being connected via a tilt joint and closeable by a spring force, wherein the latching lugs are disposed at one end of the first and second flexible clip legs and form a clip head, wherein externally accessible handles are disposed at an opposite end of the first and second flexible clip legs, wherein pushing the externally accessible handles together causes the clip head to open.

18. The module of claim 11 wherein the externally accessible securing part comprises a tamper-evident means that makes visible a first-time removal of the externally accessible securing part.

19. The module of claim 11 wherein the receiving element comprises bores for receiving the camshaft, wherein a body of the camshaft is inserted into the bores of the receiving element via rotary bearings in a joining process that uses thermal expansion.

20. The module of claim 11 wherein the camshaft is a first camshaft and the externally accessible securing part is a first externally accessible securing part, the module further comprising a second camshaft and a second externally accessible securing part, wherein the first and second camshafts are rotatably mounted in the receiving element, wherein cams of the first and second camshafts are positioned to act on two rows of valves, wherein the first and second camshafts are locked against rotation in angular positions by the first and second externally accessible securing parts, at least before the externally accessible securing parts are removed.

21. A module comprising:
a receiving element that is configured as a bearing frame or a covering hood and is configured to be mounted on an internal combustion engine, the receiving element comprising a receptacle;
a camshaft that is rotatably mounted on the receiving element, wherein the camshaft projects from the receiving element and is coupled to a camshaft wheel; and
a securing part that remains accessible when the receiving element is mounted on the internal combustion engine, wherein the securing part is removable, wherein the securing part is configured to maintain the camshaft in an angular position and prevent the camshaft from rotating, wherein prior to removal the securing part extends through an aperture of the camshaft wheel and through or into the receptacle of the receiving element.

22. The module of claim 21 further comprising the camshaft wheel.

23. The module of claim 22 wherein the camshaft wheel is configured as a toothed wheel or a belt wheel.

24. The module of claim 21 wherein the securing part further comprises two flexible clip legs with latching lugs, wherein the latching lugs of the two flexible clip legs engage with the camshaft wheel.

25. The module of claim 24 wherein the securing part further comprises two externally accessible handles, wherein squeezing the two externally accessible handles towards one another causes the latching lugs of the two flexible clip legs to separate and disengage from the camshaft wheel.

26. The module of claim 21 wherein the securing part includes a tamper-evidence mechanism.

27. A securing part for maintaining a camshaft that is rotatably mounted on a receiving element in an angular position prior to mounting the receiving element with the camshaft on an internal combustion engine, wherein prior to removal the securing part extends through an aperture of a camshaft wheel coupled to the camshaft and into or through a receptacle in the receiving element so as to prevent rotation of the camshaft and the camshaft wheel relative to the receiving element.

28. The module of claim 27 wherein the securing part further comprises two flexible clip legs with latching lugs, wherein the latching lug of each flexible clip leg engages the camshaft wheel to retain the securing part to the camshaft wheel.

29. The module of claim 28 wherein the securing part further comprises two externally accessible handles, wherein squeezing the two externally accessible handles towards one another causes the latching lugs of the two flexible clip legs to separate and disengage from the camshaft wheel, thereby allowing removal of the securing part.
